(19) United States
(12) Patent Application Publication
(10) Pub. No.: US 2005/0060639 A1
(43) Pub. Date: Mar. 17, 2005

(54) Content inspection for input print data file

(75) Inventors: Itaru Furukawa, Kyoto (JP); Masayuki Fukase, Kyoto (JP)

Correspondence Address: McDERMOTT, WILL & EMERY, 600 13th Street, N.W., Washington, DC, 20005-3096, US

(73) Assignee: DAINIPPON SCREEN MFG. CO., LTD.

(21) Appl. No.: 10/919,449

(22) Filed: Aug. 17, 2004

(30) Foreign Application Priority Data
Sep. 11, 2003 (JP) 2003-319133

(51) Int. Cl. G06F 17/00

(52) U.S. Cl. 715/500

(57) ABSTRACT

A technique of inspecting an input print data file to determine whether or not a printed image has good reproducibility is provided. A content type identification module 321 identifies a content type of each object contained in the input print data file PD0. A characteristic value calculator 322 calculates a characteristic value relating to reproducibility of each object which is pre-selected according to the content type of the object. A characteristic value judgment module 323 determines based on the calculated characteristic value whether or not each object meets a judging condition relating to reproducibility of image portion represented by the object.

### CROSS-REFERENCE TO RELATED APPLICATIONS

The present application claims the priority based on Japanese Patent Application No. 2003-319133 filed on Sep. 11, 2003, the disclosure which is hereby incorporated herein by reference in its entirety.

### BACKGROUND OF THE INVENTION

1. Field of the Invention

The present invention relates to an inspection of input print data file for print data processing.

2. Description of the Related Art

With the progress of computer technology, computer-based digitalization has come into widespread use even in prepress systems for commercial printing. A digital prepress system receives an input print data file (for example, PDF data or PostScript data, PostScript being a trademark of Adobe Systems Incorporated), and performs various print data processing on this input print data file to generate binary plate data. Then, this plate data is used to output a printing plate or screen film. In addition, recently on-demand printing is carried out in which binary print data is generated in the prepress system, and then sent to an on-demand printer for direct printing. In this specification, the overall processing for generating such print data is referred to as “prepress process” or “print data processing.” The “print data” includes both plate data and print data for on-demand printing (i.e. print data in a narrow sense).

Since the print data processing is time and cost consuming, it is desired to inspect whether or not the input print data file has any errors. For example, a technique is disclosed in JP 2002-215725A that inspects whether or not an input print data condition contained in an input print data file meets a predetermined judging condition.

The input print data inspection according to this prior art determines whether or not input print data conditions (i.e. image resolution, sizes and font types of characters used, and the like) are acceptable. However, such a technique inspects only the input print data conditions but does not inspect whether or not a printed image has sufficient image reproducibility. Consequently, even if the print data processing is performed on the input print data file that has passed the inspection for input print data conditions, the resulting print may have poor reproducibility.

### SUMMARY OF THE INVENTION

An object of the present invention is to provide a technique of using an input print data file to inspect whether or not a printed image has sufficient image reproducibility.

In one aspect of the present invention, there is provided a print data processing device. The print data processing device includes: a content inspector configured to inspect an input print data file input for print data processing to determine whether or not a print image represented by the input print data file has sufficient image reproducibility prior to performing the print data processing. The content inspector includes: a content type identification module configured to identify a content type of each object of a plurality of objects, the plurality objects being image parts contained in the input print data file; a characteristic value calculator configured to calculate a characteristic value relating to reproducibility of the each object, a method of calculating the characteristic value being pre-selected according to the content type of the each object; and a judgment module configured to determine based on the calculated characteristic value whether or not the each object meets a judging condition relating to reproducibility of an image part represented by the each object.

Since this device calculates a characteristic value relating to reproducibility of each object, and then determines based on the calculated characteristic value whether or not the reproducibility of the object is good, the input print data file is inspected as to whether or not the printed image has sufficient image reproducibility. In addition, since the characteristic values are set according to content types of objects, and a characteristic value suitable for a content type is used to inspect reproducibility of each object.

The present invention may be embodied in a variety of forms, such as a method and device for processing print data, a method and device for inspecting input print data, a computer program for implementing functions of such a method or device, and a recording medium storing such computer program.

### BRIEF DESCRIPTION OF THE DRAWINGS

FIG. 1 is a schematic diagram that shows the overall structure of a prepress system according to one embodiment of the present invention.

FIG. 2 is a block diagram that illustrates the internal structure of the input print data content inspection module 320.

FIG. 3 is a schematic diagram that illustrates an example of print image represented by the input print data file PD0 subject to the prepress data processing in this embodiment.

FIG. 4 is a flowchart that shows a processing routine of the input print data content inspection according to this embodiment.

FIG. 5 is a graph that shows the highlight density value Dh and the shadow density value Ds obtained through the analysis of image content.

FIGS. 6A through 6C show various tone conversion characteristics.

FIG. 7 is a schematic diagram that illustrates an example of window that displays check results of print data content.

### DESCRIPTION OF THE PREFERRED EMBODIMENT

Preferred embodiments of the present invention will be described in the following order.
A. Overall Structure of System
B. Processing According to Embodiment
C. Modifications

A. Overall Structure of System:

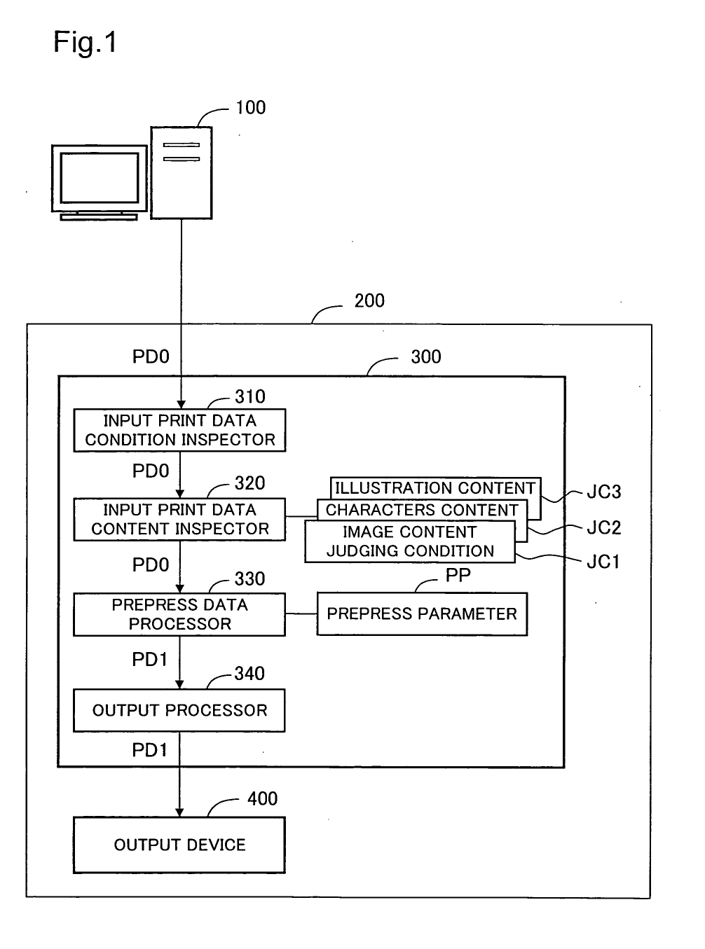

FIG. 1 is a schematic diagram that shows the overall structure of a prepress system according to one embodiment of the present invention. This prepress system includes a design device 100 for designing a print and generating an input print data file PD0; and a print data processing system 200 for generating either a plate or print based on the input print data file PD0. The print data processing system 200 includes a print data processing device 300 and an output device 400. The output device 400 may include a preliminary proof output device for printing a preliminary proof, a halftone proof output device for outputting a proof of print that has undergone the halftone process (or screening process), a plate output device for producing a printing plate directly from print data PD1, an on-demand printer for printing the print directly from the print data PD1. The print data processing device 300 is connected to a display device (not shown) such as a CRT display or a LCD display, which can display a user setup window for setting judging conditions for the input print data file, and inspection results of input print data file.

The print data processing device 300 includes an input print data condition inspector 310, an input print data content inspector 320, a prepress data processor 330, and an output processor 340. The input print data condition inspector 310 inspects whether or not an input print data condition contained in the input print data file PD0 meet a predetermined judging condition. The input print data condition includes image resolution, and sizes and font types of characters used. This process for inspecting input print data conditions is also referred to as “preflight check.”

The input print data content inspector 320 inspects each object (also referred to as “image object”), which is an image part contained in the input print data file PD0, to determine whether or not an image to be printed has sufficient reproducibility. The objects contained in the input print data file PD0 include, for example, an image content, a characters content, and an illustration content. The image content is typically a photo image, but a document created by a document generating application program may be contained as an image content in the input print data file PD0. The characters content is a character string expressed by information such as character code, font type, and font size. The illustration content is an image drawn through graphic commands. The “illustration content” is also referred to as “graphic content.” In this specification, the term “content” means a content of an image represented by an object.

The inspection (hereinafter referred to as “content inspection”) performed by the input print data content inspector 320 uses an image content judging condition JC1, a characters content judging condition JC2, and an illustration content judging condition JC3. As described later, the input print data content inspector 320 identifies which of the three content types each object is, calculates a characteristic value corresponding to the identified content type, and then applies the corresponding judging condition to determine whether or not the object is to be sufficiently reproduced. Both the input print data condition inspector 310 and the input print data content inspector 320 inspect prior to performing the prepress data processing on the input print data file PD0. Therefore, these inspections can find out an input print data file that is likely to have an error prior to performing the prepress data processing.

The prepress data processor 330 performs a variety of processes included in prepress processing (or print data processing) according to prepress parameters PP specified for the input print data file PD0 to generate the print data PD1. The prepress processing includes the processes described below.

(1) Pagination/Imposition Process:

The prepress data processor 330 performs a so-called pagination process and imposition process (a process for arranging a plurality of pages on a single plate). In addition, the processor 330 has a function of generating the processed data into RIP (Raster Image Process) data for preliminary proofing and then causing the preliminary proof output device to output a proof according to the RIP data.

(2) Automatic Prepress Process:

The prepress data processor 330 performs the tone conversion process and other processes such as so-called overprint, setting white borders, and trapping.

(3) Halftone Proof Process:

The prepress data processor 330 performs a so-called RIP process (Raster Image Processing) and halftone process (or screening process) to generate raster data (also referred to as “RIP data for halftone proofing”) representing printing plates for the respective ink colors (for example, four colors of YMCK) in a specific output resolution. The proof according to the RIP data for halftone proofing is output by the halftone proof output device.

(4) Final Output Process:

The prepress data processor 330 performs the RIP process on the print data to generate the output data PD1 appropriate for the output device 400. The output data PD1 is transferred to the output device 400 via the output processor 340.

The prepress parameters PP include process conditions for the entire processing and the respective processes. The functions of the modules 310, 320, 330, and 340 included in the print data processing device 300 are realized by application programs stored on a recording medium.

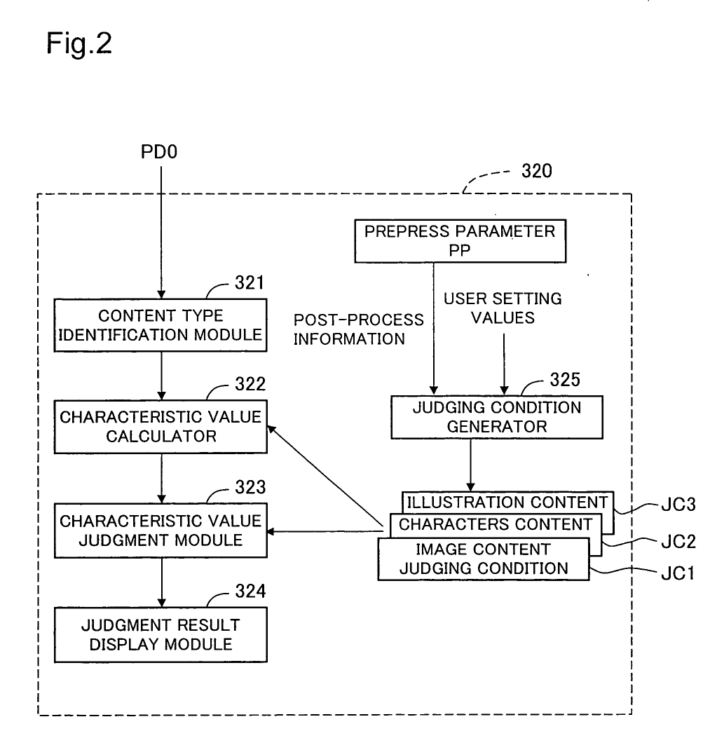

FIG. 2 is a block diagram that illustrates the internal structure of the input print data content inspector 320. The input print data content inspector 320 includes a content type identification module 321, a characteristic value calculator 322, a characteristic value judgment module 323, a judgment result display module 324, and a judging condition generator 325. The judging condition generator 325 generates the judging conditions JC1-JC3 for the respective contents based on at least one of:
1) information concerning the prepress process (referred to as “downstream-process”) contained in the prepress parameters PP, and
2) judging conditions set by the user.

The calculation and judgment of characteristic values are performed based on these judging conditions. The functions of the units 321-325 will be described later.

B. Processing According to Embodiment:

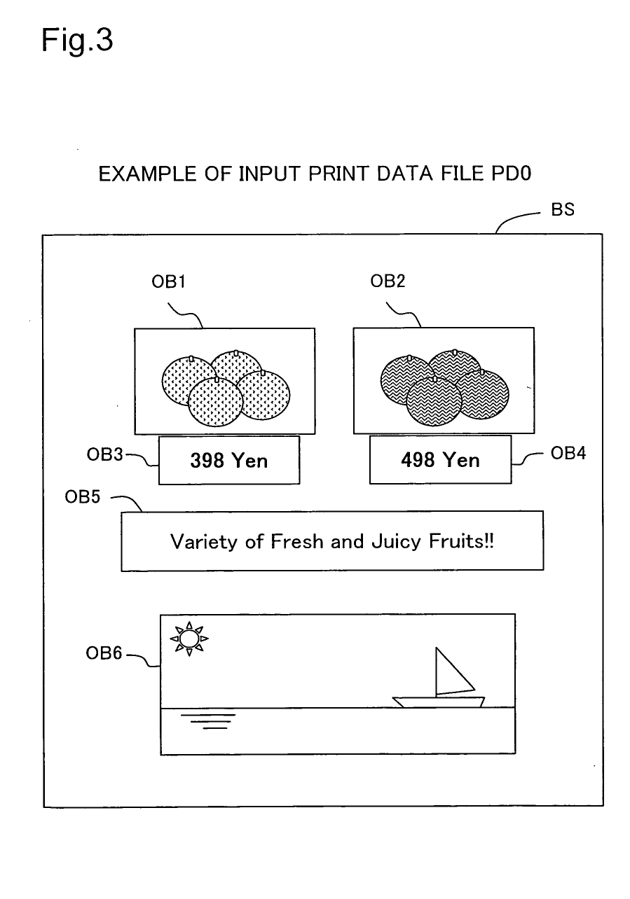

FIG. 3 is a schematic diagram that illustrates an example of print image represented by the input print data file PD0 subject to the prepress data processing in this embodiment. This print image includes six image parts OB1-OB6 that are arranged at respective predetermined positions on a board sheet, or a layout sheet, BS. Outer frames of the image parts, which are shown for convenience of illustration, are not included in the actual image. Data of each image part is contained as a single independent object in the input print data file PD0. The first and second objects OB1 and OB2 are image contents representing natural images or photo images. The third to fifth objects OB3-OB5 are characters contents, and the sixth object OB6 is an illustration content. The following describes the inspection of input print data content applied to such input print data file PD0.

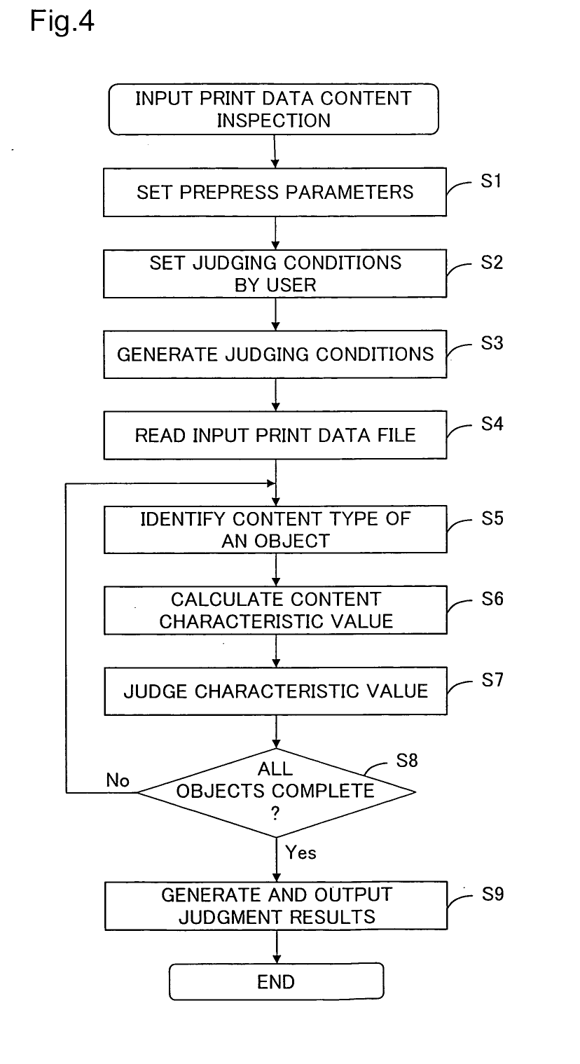

FIG. 4 is a flowchart that shows a processing routine of the input print data content inspection according to this embodiment. At step S1, the user sets the prepress parameters PP (shown in FIG. 1) by use of an input device of the print data processing system 200. The prepress parameters PP include an order of performing a variety of process steps (e.g. pagination/imposition process step, automatic prepress process step, halftone proofing process step, final output process step, and the like) on the input print data file PD0, and detailed process conditions for each process step (e.g. type of halftone dot used for the halftone process, tone conversion characteristics, and the like). The prepress parameters PP are set for each job (or each prepress processing), and therefore the data file containing the prepress parameters PP is also referred to as “job ticket.”

At step S2, the user inputs user settings (described later) of judging conditions for the input print data content inspection. At step S3, the judging condition generator 325 uses the downstream-process information of the prepress parameters PP and the judging conditions set by the user at step S2 to generate judging conditions JC1-JC3 for the respective contents. The details of the judging conditions JC1-JC3 will be described later. At step S4, the input print data content inspector 320 reads the input print data file PD0 subject to the processing. At step S5, the content type identification module 321 identifies which type each object has among the three content types: an image content type, a characters content type, and an illustration content type. At step S6, the characteristic value calculator 322 calculates a characteristic value of each object according to the content type of the object. At step S7, the characteristic value judgment module 323 compares the characteristic value with the judging conditions JC1-JC3 to judge whether or not an image portion of the content has a poor reproducibility. At step S8, steps S5-S7 are repeated until all of the objects have been inspected. When all of the objects have been inspected, the judgment result display module 324 generates an image indicating the judgment results to display or print the image of judgment results at step S9.

For example, the following describes the characteristic values of the three contents and judging methods thereof in this embodiment.

I-a. Characteristic values of image content and judging method thereof (described later in detail):

[Characteristic value a1]=Highlight density value Dh of image content;

Tolerable value: Tolerable highlight density value TDh=0.50 (user setting value);
Judging condition: If TDh<Dh, a warning is given because the image part is too dark.
   [Characteristic value a2]=Shadow density value Ds of image content;
Tolerable value: Tolerable shadow density value TDs=1.50 (user setting value);
Judging Criterion: If Ds<TDs, a warning is given because the image part is too light.
   [Characteristic value a3]=Predicted halftone moiré area Sm (pixels) of image content;
Tolerable value: Tolerable halftone moiré area TSm=15,872 pixels (user setting value);
Judging condition: If TSm<Sm, a warning is given because the halftone moiré is conspicuous in the image.
   [Characteristic value a4]=Noise amount Pwn of image content;
Tolerable value: Tolerable noise amount TPwn=8 (user setting value);
Judging condition: If TPwn<Pwn, a warning is given because there is too much noise.

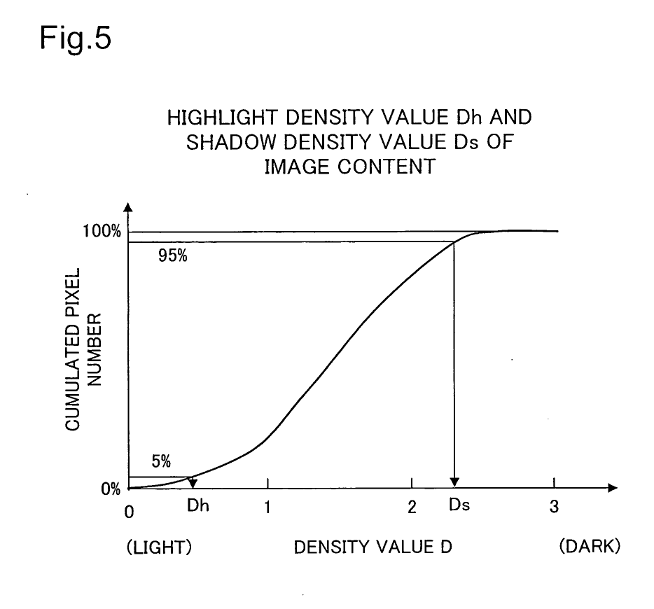

FIG. 5 is a graph that shows the highlight density value Dh and the shadow density value Ds obtained through the analysis of image content. The highlight density value Dh represents a density value where a cumulated pixel number reaches a first predetermined percentage (5% in FIG. 5) in the cumulative histogram relative to density values of pixels in the image content. The shadow density value Ds represents a density value where the cumulated pixel number reaches a second predetermined percentage (95% in FIG. 5). The tolerable highlight density value TDh is an upper limit of appropriate highlight density value that allows the image to have appropriate tone characteristics. If the highlight density value Dh of the image content is larger than the tolerable value TDh (that is, the value Dh indicates darker), it is determined that there is a problem with image reproducibility since the entire image is too dark. The tolerable shadow density value TDs is a lower limit of appropriate shadow density value that allows the image to have appropriate tone characteristics. If the shadow density value Ds of the image content is smaller than the tolerable value TDs (that is, the value Ds indicates lighter), it is determined that there is a problem with image reproducibility since the entire image is too light. Thus, the judgment is performed on the highlight density and shadow density values in order to determine whether or not the image content has appropriate tone characteristics.

The predicted halftone moiré area Sm of the image content is obtained by means of a simulation to predict the area of halftone moiré that will occur in a halftone image to be obtained through the halftone process (or screening process) of the image content. As well known, the halftone moiré occurs due to interference of halftone dot periodicity and the image content. For example, a simulation image generator 10A, a reference image generator 10B, and a moiré detector 30 that are disclosed in FIG. 2 of JP 2001-86355A by the present applicant can be used to calculate the predicted halftone moiré area Sm. Alternatively, a method and apparatus that are disclosed in JP 2001-86369A by the present applicant can be used to calculate the predicted halftone moiré area Sm. The disclosures of JP2001-86355A and JP2001-86369A are hereby incorporated herein by reference for all purposes. If the predicted halftone moiré area Sm is larger than the tolerable value TSm, it is determined that there is a problem with image reproducibility since the halftone moiré is conspicuous. The tolerable halftone moiré area TSm may be expressed in the size of area instead of the number of pixels. Specifically, for example, if the tolerable halftone moiré area TSm is set to an area of 8 mm×8 mm, and the image content has the resolution of 400 dpi, then the tolerable halftone moiré area TSm in units of pixel number is equal to 8×8×(400×400)/(25.4×25.4) [pixels]. The above tolerable value TSm=15,872 pixels is calculated in this manner.

The noise amount Pwn of the image content represents an amount of high-frequency component included in the image content. For example, the noise amount Pwn can be obtained as an average value of absolute amplitudes of high-frequency components within a predetermined range after applying Laplacian filter to the image content. If the noise amount Pwn of the image content is larger than the tolerable value TPwn, it is determined that there is a problem with image reproducibility for the reason of too much noise.

I-b. Characteristic values of characters content and judging method thereof:

[Characteristic value b1]=One-line character number Nc of characters content;

Tolerable value: Maximum one-line character number TNc=36 (user setting value);
Judging condition: If TNc<Nc, a warning is given because there are too many characters per line.
   [Characteristic value b2]=Price value of characters content;
Tolerable value: Quantity of listed prices TNv=10 (user setting value), and price values TVL(1)-TVL(TNv) (user setting value);
Judging condition: If the characters content has a price that does not correspond to any price value TVL(1)-TVL(TNv) on a price list, a warning of error is given.

The one-line character number Nc represents a number of characters arranged on a same level (or same line position) of the board sheet BS (FIG. 3). If the one-line character number Nc of the characters content is larger than the tolerable value TNc, it is determined that there is a problem with image reproducibility since the characters content has some error.

The price list contains prices used for a flier or catalogue of goods. Since the price values are very important for the flier and catalogue, it is preferable to check for errors in the price values when receiving the input print data. It can be determined whether or not a characters content represents a price, based on whether or not a price-indicating character(s) such as “yen”, “¥”, “dollars”, or “$” is attached before or after a numeric character string. If the price value of the characters content is other than the price values TVL on the price list, it is determined that there is a problem with image reproducibility since the characters content has some error.

I-c. Characteristic values of illustration content and judging method thereof:

[Characteristic value c1]=Gradation tone range LR of illustration content;

Tolerable value: Steep tone conversion range TLR (which is calculated from tone conversion characteristics of downstream-process);
Judging conditions: If the illustration content is a gradation image area and its tone range LR is within the steep tone conversion range TLR, a warning is given because a tone jump occurs in the gradation.

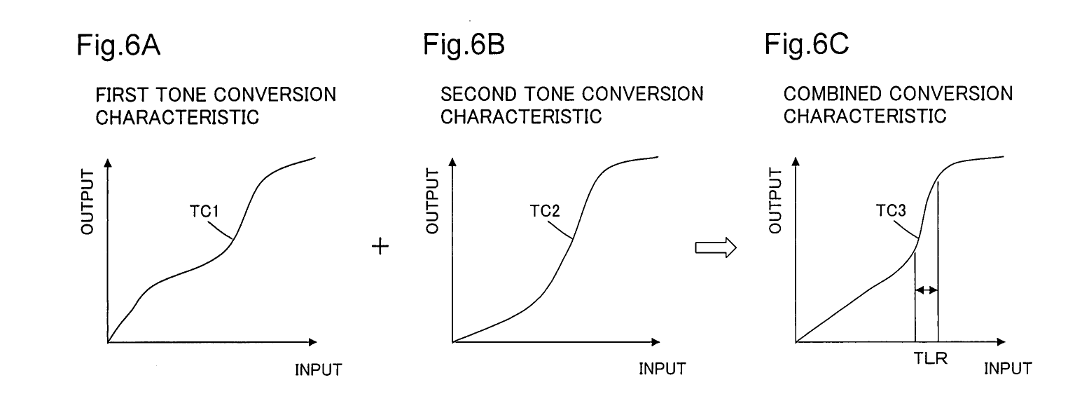

FIGS. 6A through 6C show tone conversion characteristics and the steep tone conversion range TLR. It is assumed that two tone conversion processes are performed at the downstream-processes by the prepress data processor 330. Two tone conversion characteristics TC1 and TC2 are specified within the input print data file PD0. A combined tone conversion characteristic TC 3 is a combination of the two tone conversion characteristics TC1 and TC2. This combining can be considered as simulation of the two tone conversion processes. The steep tone conversion range TLR is a range where the slope of the combined tone conversion characteristic TC3 is larger than or equal to a predetermined value. Since the tone conversion is significant within the tone range TLR, tone jump is likely to occur in the gradation area that includes a color within the tone range TLR. Therefore, if the tone range of the gradation area in the illustration content includes a tone within the steep tone range TLR, it is determined that there is a problem with image reproducibility about the gradation area. If the downstream-processes include a single tone conversion process, the steep tone range TLR can also be determined in the same manner based on the single tone conversion characteristic.

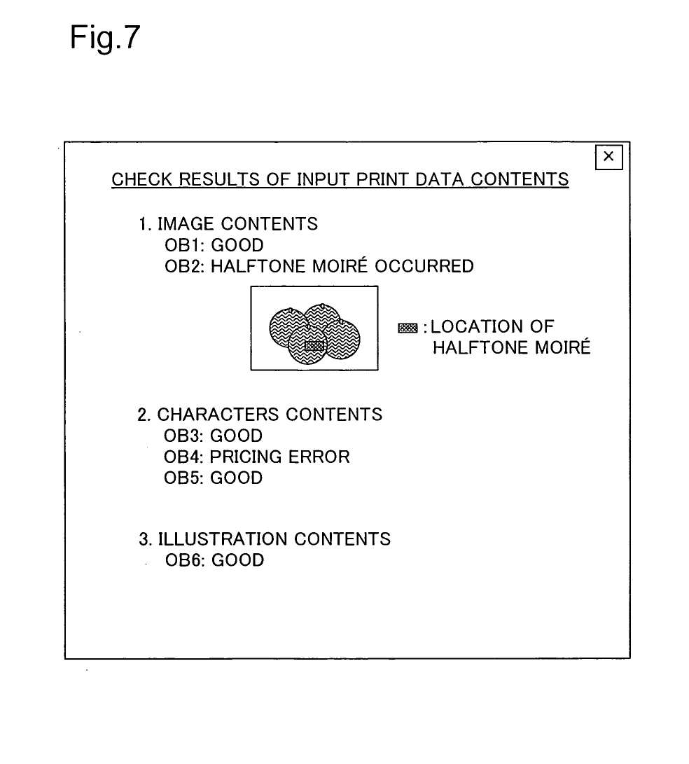

FIG. 7 shows an example of a window that displays check results of input print data contents. In this example, there are displayed a warning that the halftone moiré has occurred in the object OB2, which is an image content, of the input print data file of FIG. 3, and a location of the halftone moiré in the image content. Furthermore, there is displayed a warning that the object OB4, which is a characters content, has a pricing error. Thus, displaying check results of input print data contents enables an operator to readily know whether or not there is an object (or content) that has a problem with image reproducibility, and what kind of problem it is. If there is the problem, the input print data file PD0 can be corrected prior to performing the subsequent print data processing.

The display of judgment results of halftone moiré occurrence may take a variety of display forms such as a form only indicating if moiré occurs or not, or another form indicating the size of the moiré. In addition, the displays of judgment results of the other contents may also a variety of forms.

As described above, in this embodiment the different characteristic values are used for an image content, characters content, and illustration content respectively to determine whether or not they have a problem with image reproducibility. Therefore, it is possible to determine at the time of receiving the input print data whether or not a problem occurs when the print including these contents is to be reproduced.

C. Modifications:

The present invention is not limited to the above embodiments, but there may be a variety of aspects without departing from the scope or spirit of the present invention. For example, the following modifications may be implemented.

C1. Modification 1:

The characteristic values for the three types of contents are illustrative only, and other kinds of characteristic values may be used for the content check. It is preferable that the content check using at least one characteristic value is performed on each type of content.

C2. Modification 2:

Although the above embodiment uses the three content types, any types may be used as the content types. It is preferable that different characteristic values are used for the respective contents to determine whether the image has good reproducibility.

1. A print data processing device comprising:
a content inspector configured to inspect an input print data file input for print data processing to determine whether or not a print image represented by the input print data file has good reproducibility, prior to performing the print data processing,
wherein the content inspector comprises:
a content type identification module configured to identify a content type of each of a plurality of objects, the plurality objects being image parts contained in the input print data file;
a characteristic value calculator configured to calculate a characteristic value relating to reproducibility of the each object, a method of calculating the characteristic value being pre-selected according to the content type of the each object; and
a judgment module configured to determine, based on the calculated characteristic value, whether or not the each object meets a judging condition relating to reproducibility of an image part represented by the each object.

2. A print data processing device according to claim 1, wherein the content types of the objects include a natural image content, a characters content, and an illustration content, and different characteristic values are set for the respective content types.

3. A print data processing device according to claim 1, wherein a characteristic value for an object representing a natural image content includes a value relating to occurrence of halftone moiré in a printed image.

4. A print data processing device according to claim 1, wherein a characteristic value for an object representing a characters content includes a value that indicates whether or not a numeric character representing a price corresponds to one of price values registered in advance.

5. A print data processing device according to claim 1, wherein the character amount calculator calculates at least one characteristic value by simulating a particular process to be performed during the print data processing.

6. A computer program product for inspecting an input print data file input for print data processing to determine whether or not a print image represented by the input print data file has good reproducibility, prior to performing the print data processing, the computer program product comprising:
a computer readable medium; and
a computer program stored on the computer readable medium, the computer program including:
a first program for causing a computer to identify a content type of each of a plurality of objects, the plurality objects being image parts contained in the input print data file;
a second program for causing the computer to calculate a characteristic value relating to reproducibility of the each object, a method of calculating the characteristic value being pre-selected according to the content type of the each object; and
a third program for causing the computer to determine, based on the calculated characteristic value, whether or not the each object meets a judging condition relating to reproducibility of an image part represented by the each object.

7. A computer program product according to claim 6, wherein the content types of the objects include a natural image content, a characters content, and an illustration content, and different characteristic values are set for the respective content types.

8. A computer program product according to claim 6, wherein a characteristic value for an object representing a natural image content includes a value relating to occurrence of halftone moiréin a printed image.

9. A computer program product according to claim 6, wherein a characteristic value for an object representing a characters content includes a value that indicates whether or not a numeric character representing a price corresponds to one of price values registered in advance.

10. A computer program product according to claim 6, wherein the second proguram calculates at least one characteristic value by simulating a particular process to be performed during the print data processing.
